(19) United States
(12) Patent Application Publication
(10) Pub. No.: US 2016/0192774 A1
(43) Pub. Date: Jul. 7, 2016

(54) APPARATUS FOR SUPPORTING A TABLET COMPUTING DEVICE

(71) Applicant: DMAC International Co., Ltd., Seoul (KR)

(72) Inventor: Yoon Jae Hwang, Irvine, CA (US)

(21) Appl. No.: 14/589,451

(22) Filed: Jan. 5, 2015

(51) Int. Cl. A47B 23/00; A47B 23/04; G06F 1/16

(52) U.S. Cl. CPC A47B 23/007; G06F 1/1633; A47B 23/04

(57) ABSTRACT

An apparatus for supporting a tablet computing device includes an arm having first and second ends; a support base detachably fastened to the second end of the arm by an attachment member wherein the support base includes a recess formed on the bottom surface of the support base and a through hole formed on the recess; and a receiving plate, mounted on the first end of the arm to receive the tablet computing device. The receiving plate includes a receiving portion having an annular mounting portion with an inner rim and outer rim which are concentric such that the tablet computing device can mount on the annular mounting portion facing downward for allowing the user to see the screen of the tablet computing device from below the receiving portion.

### FILED OF THE INVENTION

The present invention relates to an apparatus for supporting a tablet computing device and, more particularly, to an apparatus for supporting a tablet computing device having an arm, a support base, and a receiving plate. The apparatus is configured to receive and support a tablet computing device, which faces downward, for allowing a user to see the screen of the tablet computing device from below the apparatus in supine position.

### BACKGROUND OF THE INVENTION

Portable electronic devices, such as tablet computing devices, smart phones, e-book readers and the like, have become popular and are being widely used. The portable electronic devices perform a lot of functions, which used to be only possible with a powerful desktop or laptop computer, allowing users to further free themselves from typical office environment. However, a user needs to hold a portable electronic device in his hand for using it and this is rather inconvenient and may lead to health problems. For example, if a user wishes to use a portable electronic device in supine position, there is no convenient way to hold the electronic device in his hand to use it. Even though he manages to use it while holding the device, holding a device for an extended period of time puts great pressures on the user's neck and arm muscles and this may cause damages to his health. Moreover, there is risk that a user drops the device and the device falls right onto his face or body. This may cause an injury to him.

Some portable electronic supporting apparatuses have been introduced, but these are not very functional, not allow users to use the apparatus in a wide variety of positions or ways. In addition, such supporting apparatuses do not enable users to use the supporting apparatuses in various positions and it is not convenient for a user to change his positions while using a portable electronic device. Moreover, conventional supporting apparatuses do not have a simple structure or construction for easy assembling or dissembling of the apparatus to allow users to carry the apparatus around for using it in a variety of ways or positions.

Accordingly, there has been a need for an apparatus for supporting a tablet computing device having a simple structure and allowing a user to use it hands-free in a number of different ways or positions.

### SUMMARY OF THE INVENTION

The present invention contrives to solve the disadvantages of the prior art. The present invention provides an apparatus for supporting a tablet computing device and, more particularly, to a supporting apparatus having an arm, a support base, and a receiving plate.

The object of the invention is to provide an apparatus for supporting a tablet computing device which includes an arm, a support base, and a receiving plate. The arm includes a first end securely mounted onto the receiving plate and a second end detachably fastened to the support base.

Another object of the invention is to provide an apparatus for supporting a tablet computing device which includes an arm, a support base, and a receiving plate. The support base, detachably fastened to the second end of the arm, includes a recess formed on the bottom surface of the support base and a through hole formed on the recess. The through hole and the recess receive the attachment member therein for mounting the second end of the arm to the support base.

Still another object of the invention is to provide an apparatus for supporting a tablet computing device which includes an arm, a support base, and a receiving plate. The receiving plate mounted on the arm to receive the tablet computing device includes a receiving portion. The receiving portion includes an outer rim wall and annular mounting portion having an inner rim and outer rim. The inner and outer rims are concentric such that the tablet computing device can mount on the annular mounting portion such that the tablet computing device is facing downward allowing the user to see the screen of the tablet computing device from below the receiving portion.

The advantages of the present invention are: (1) the apparatus for supporting a tablet computing device of the present invention supports a tablet computing device for allowing a user to see the screen of the device in supine position; (2) the apparatus of the present invention allow users to view a tablet computing device hands-free in various positions including supine position through easy transition between positions; and (3) the apparatus of the present invention having a simple construction or structure allows users to conveniently disassemble and reassemble the apparatus.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 shows a top-perspective view of an apparatus for supporting a tablet computing device according to the present invention;

FIG. 2 shows an exploded bottom-perspective view of the apparatus for supporting a tablet computing device according to the present invention;

FIGS. 3A, 3B, and 3C respectively show top, bottom, and front views of the receiving plate of the apparatus according to the present invention;

FIGS. 4A and 4B respectively show top and bottom views of the support base of the apparatus according to the present invention;

FIG. 5A shows a partial exploded bottom-perspective view, FIG. 5B shows a cross-sectional view taken along line A-A′ in FIG. 5A, and FIG. 5C shows a front view of the attachment member of the present invention;

FIG. 6A shows an assembled top-perspective view of an apparatus for supporting tablet computing device with the circular complementary plate placed therein, and FIG. 6B shows a top view of the circular complementary plate; and

FIGS. 7A and 7B show a user using the present invention.

### DETAILED DESCRIPTION EMBODIMENTS OF THE INVENTION

Reference will now be made in details to the preferred embodiments of the present invention, examples of which are illustrated in the accompanying drawings, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention.

Also, as used in the specification including the appended claims, the singular forms “a”, “an”, and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about”, it will be understood that the particular value forms another embodiment.

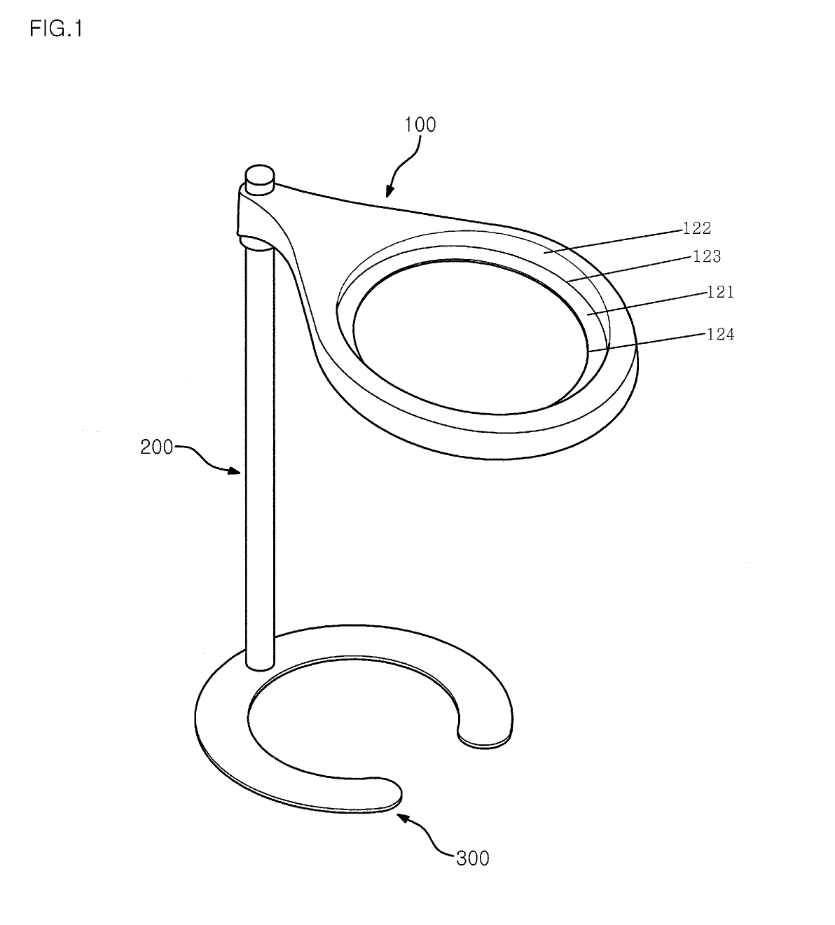

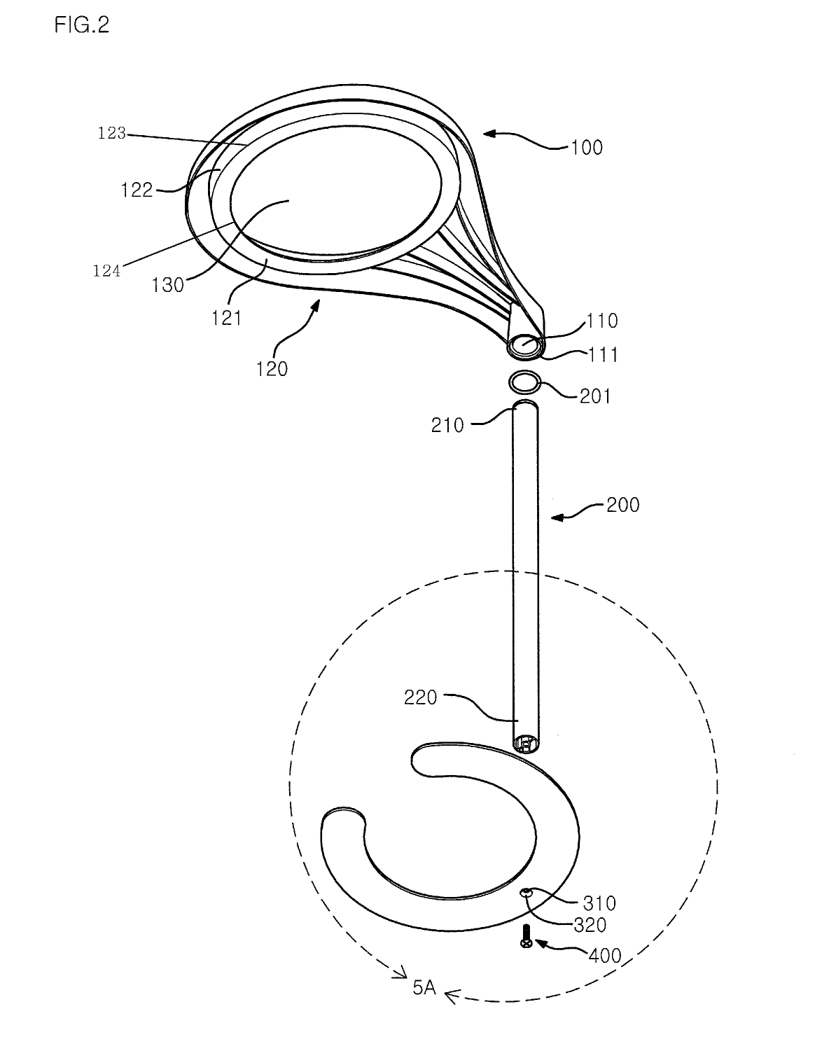

FIGS. 1 and 2 show perspective views of the apparatus for supporting a mobile electronic device a tablet computing device according to the present invention. The mobile electronic device includes a mobile phone, smart phone, tablet computing device, or personal digital assistant. The present invention is especially suitable for a table computing device, but it may be used for other mobile electronic device.

The apparatus of the present invention includes an arm 200; a support base 300 connected to the arm 200 for supporting the apparatus; and a receiving plate 100 mounted on the arm 200.

The receiving plate 100, mounted on the arm 200, includes a receiving portion 120 and the receiving portion 120 includes an annular mounting portion 121 having an inner rim 124 and an outer rim 123. The receiving portion 120 further includes an outer rim wall 122 extending upwardly from the outer rim 123 such that the outer rim wall 123 is substantially cylindrical. The inner rim 124 and the outer rim 123 are concentric such that the tablet computing device can mount on the annular mounting portion 121 such that the tablet computing device is facing downward for allowing a user to see the screen of the mobile electronic device such as tablet computing device from below the receiving portion 120. The user may rotate the receiving plate 100 and then, he can rotate the mobile electronic device mounted on the annular mounting portion 121 because the mobile electronic device is generally rectangular. In this way, the user can find the most convenient position to see the screen of the mobile electronic device in his supine position.

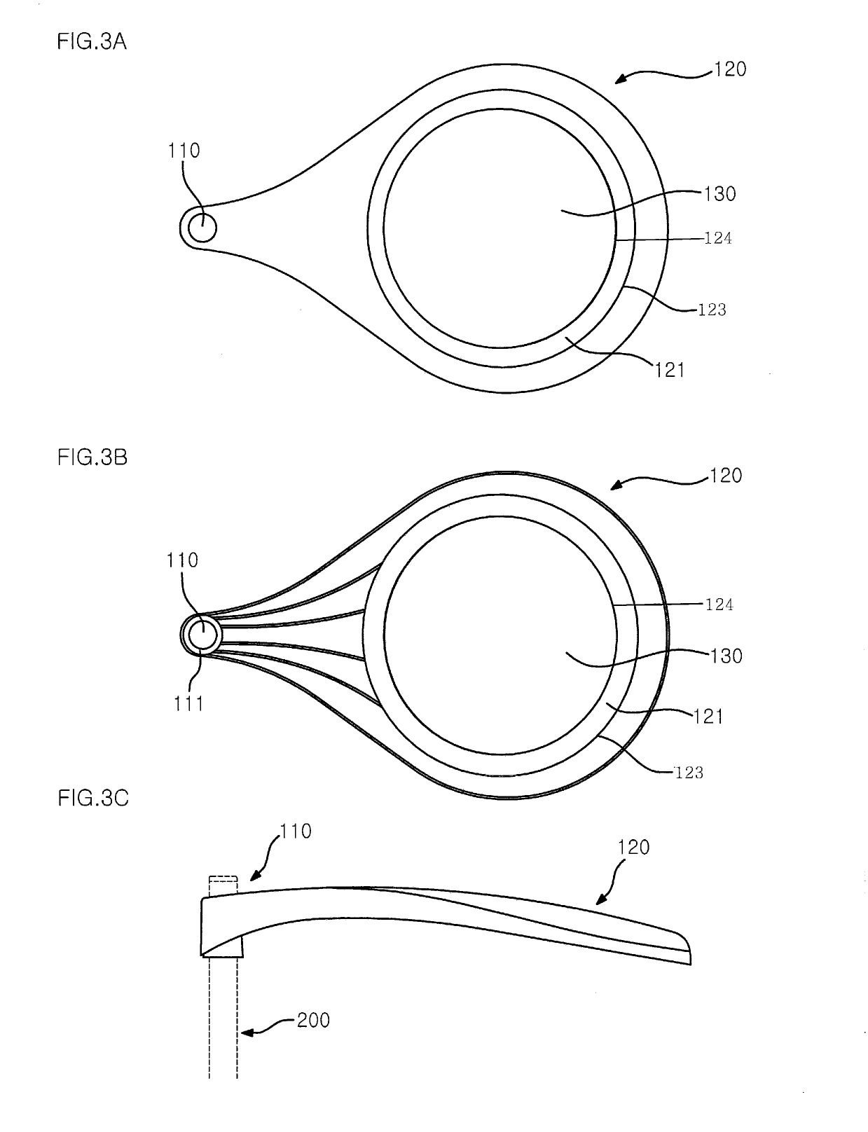

The annular mounting portion 121 may be sloped upwards towards the arm 200 as shown in FIG. 3C. The distance between a user's eye and the lower end of the screen is generally greater than the distance between the user's eye and the upper end of the screen, and because of the sloped structure of the annular mounting portion 121, the gap between the distances becomes smaller and it becomes much more convenient to see the screen of the mobile electronic device.

The outer rim wall 122 is substantially cylindrical 122. However, if the annular mounting portion 121 is sloped upwards towards the arm 200, the angle between the outer rim wall 122 and the annular mounting portion 121 may not be always a right angle. In the point near the arm 200, the angle may be greater than 90 degrees whereas in the point farther from the arm 200, the angle may be smaller than 90 degrees.

The receiving plate 100 further includes an upper through, opening 110 through which the arm 200 passes. The arm 200 has a first end 210 and the receiving plate is mounted through the first end 210. The receiving plate 100 is mounted onto the arm 200 and a sliding stop 201 is adjustably mounted on the arm 200 for preventing the receiving plate 100 from sliding down the arm 200. The arm 200 may be cylindrical and the sliding stop 201 may be an annular ring made of rubber or synthetic plastic fastened to the arm 200 by a friction fit.

The second end 220 of the arm 200 is detachably fastened to the support base 300 by an attachment mean 400. The support base 300, detachably fastened to the second end 220 of the arm 200, includes a recess 320 formed on the bottom surface of the support base and a through hole 310 formed on the recess. Alternatively, the support base 300 may be integrated with the arm 200 to form one continuous body, instead of being two separate members fastened to each other.

FIGS. 3A, 3B, and 3C respectively show top, bottom and front views of the receiving plate 120. The diameter of the outer rim 123 is substantially the same or slightly greater than a diagonal of the mobile electronic device such as a tablet computing device. The diameter of the inner rim 124 is substantially the same or slightly greater than a diagonal of the screen of the tablet computing device. The difference in diameters of the outer rim 123 and inner rim 124 defines the annular mounting portion 121 and the tablet computing device can mount on the annular mounting portion 121 such that the tablet computing device is facing downward for allowing the user to see the screen of the tablet computing device from below the receiving portion 120 through the sighting aperture 130.

The receiving place 100 further includes the upper through opening 110 through which the arm 200 passes and the lower through opening 111 formed on a lower end of the upper through opening 110. The arm 200 passes through the upper through opening 110 and lower through opening 111, and the sliding stop 201 is received in the lower through opening 111 to prevent the receiving plate 100 from sliding down the arm 200. The receiving plate 100, therefore, is rotatable with respect to the arm 200, and height adjustable along the arm 200.

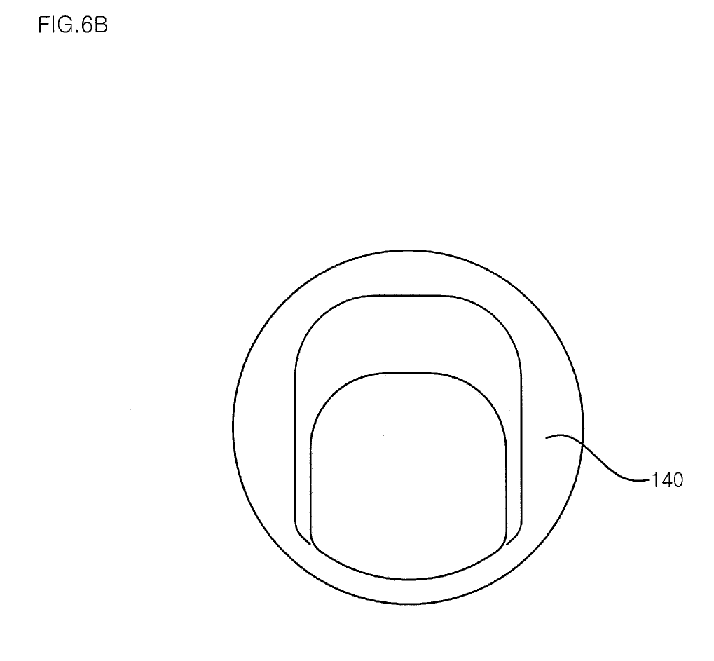

The receiving plate 100 may further include a circular complementary plate 140 having a sighting aperture 130 as shown in FIG. 6A. The FIG. 6B shows the top view of the circular complementary plate 140. The circular complementary plate 140 is adapted to mount on the receiving portion 120. The diameter of the circular complementary plate 140 is substantially the same or slightly smaller than the diameter of the outer rim 123 of the receiving portion 120 and the diameter of the circular complementary plate 140 is greater than the diameter of the inner rim 124 of the receiving portion 120. Thus, the circular complementary plate can just be placed on the receiving portion 120.

The circular complementary plate 140 has its own sighting aperture 130 as in FIG. 6A and this sighting aperture 130 can accommodate different size of a mobile electronic device. An electronic device such as a tablet computing device is mounted on the circular complementary plate 140, facing downward, and a user can see a screen of the device from below the circular complementary plate 140 through the circular sighting aperture 130.

The circular complementary plate 140 may further include a plurality of cutouts for various sizes of sighting apertures as in FIGS. 6A and 6B to accommodate various sizes of the mobile electronic devices. The plurality of cutouts allows users to flexibly change the diameter of the inner rim to make the sighting aperture 130 smaller or greater to accommodate tablet computing devices of all sizes.

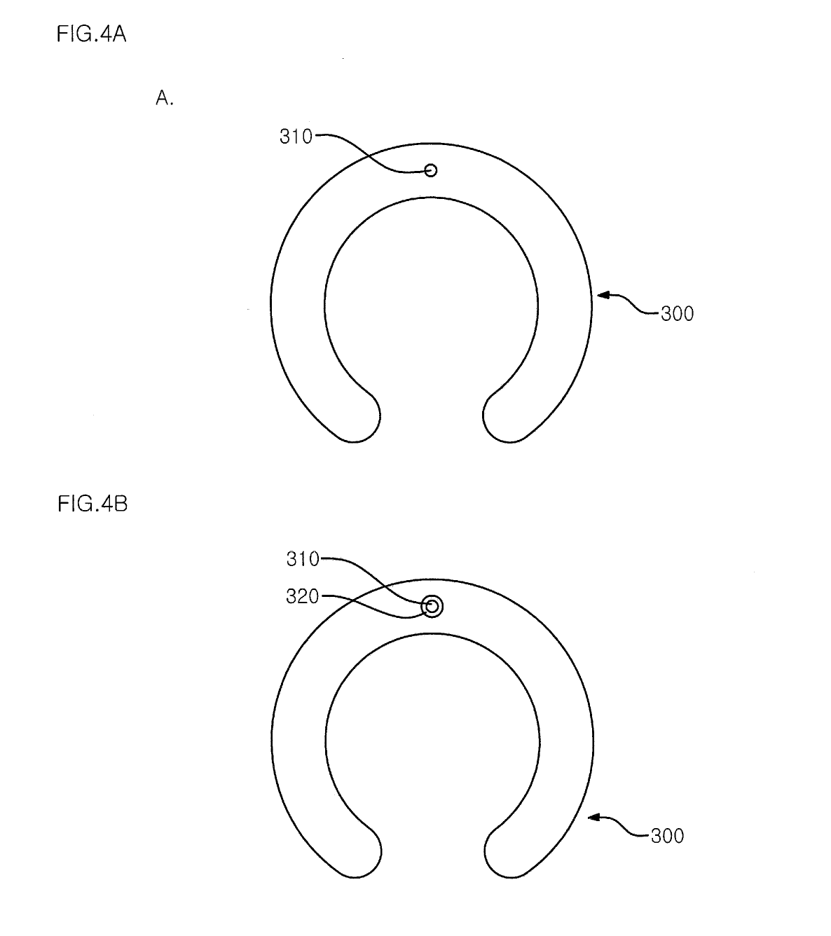

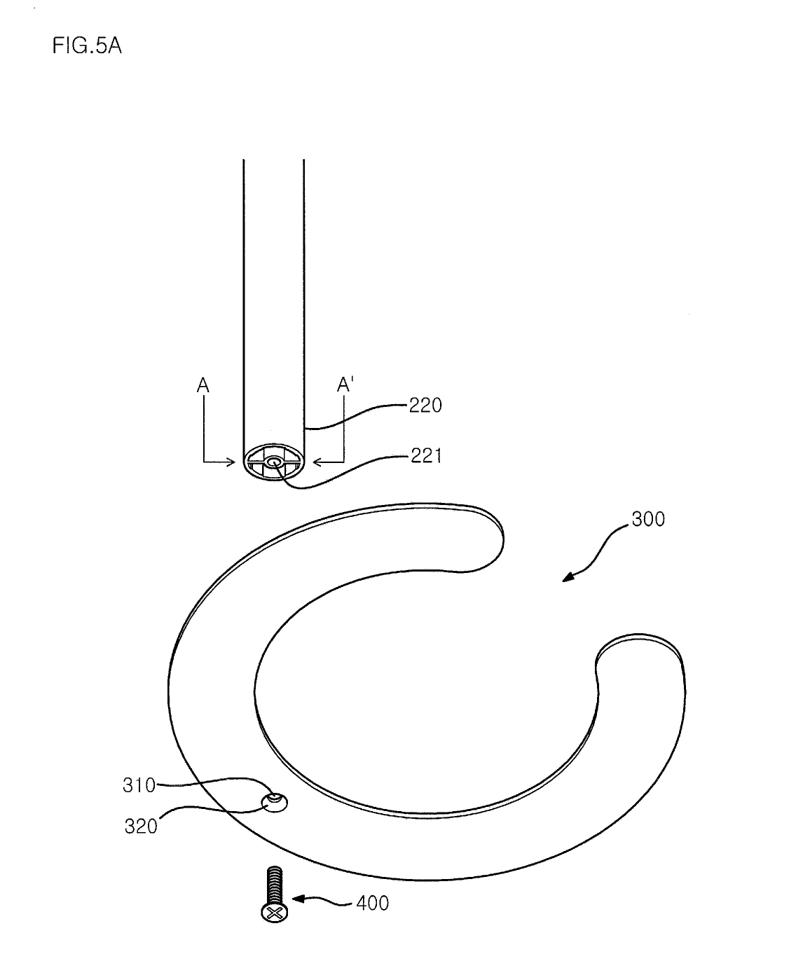

FIGS. 4A and 4B respectively show top and bottom views of the support base 300. The support base 300 may be substantially flat, making a ‘c’ shape. It may be made of metal or the similar material having high weight to provide stable support for the apparatus of the present invention. The support base 300 is heavy to prevent the apparatus from falling. The support base 300 includes a recess 310 formed on a bottom surface of the support base and a through hole 310 formed on the recess 310, The support base 300 is detachably fastened to the second end of the arm 220 by the attachment member 400. Alternatively, the support base 300 may be integrally formed and extended from the arm 200.

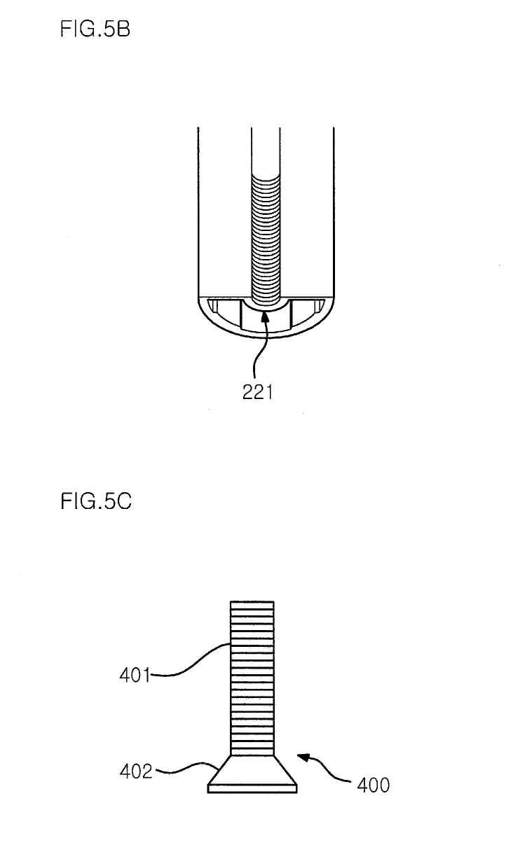

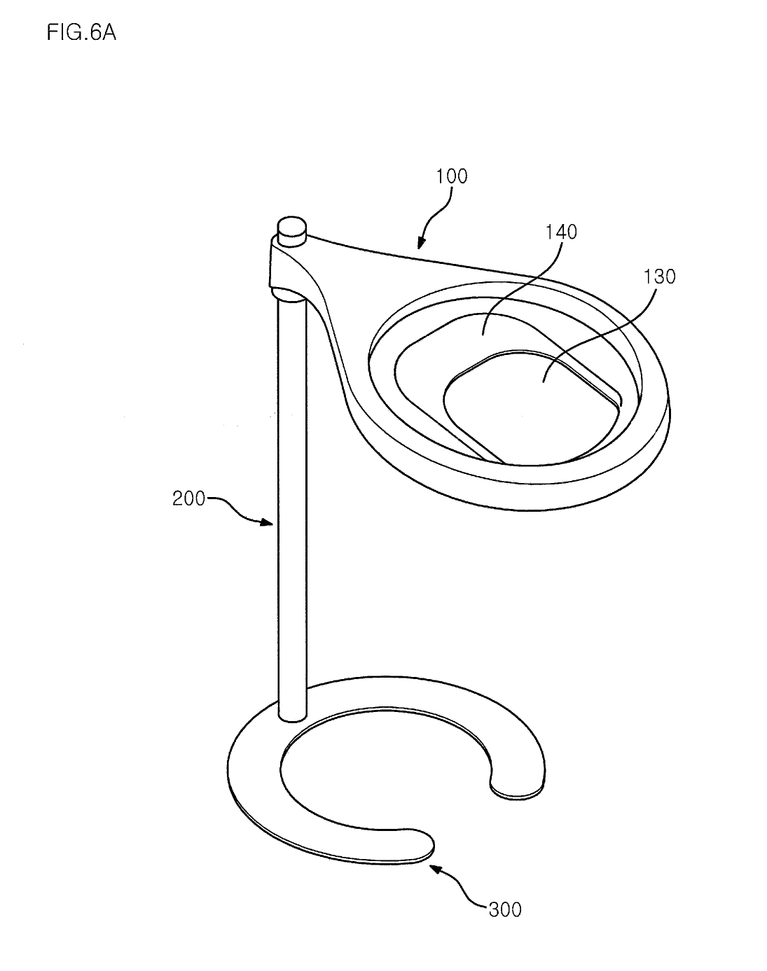

FIGS. 5A, 5B, and 5C respectfully show a partial exploded view, a cross-sectional view, and a front view of the arm 200, support base 300 and/or the attachment member 400. The second end of the arm 220 includes an internal thread 221 for receiving the attachment, member 400 through the recess 320 and through the bole 310 of the support base 300. The attachment member 400 includes a bolt head 402 and an external thread 401. The internal thread 221 is formed on the second end 220 of the arm 200 whereas the bolt head 402 is received in the recess 320 of the support base 300. The external thread 401 mates with the internal thread 221 to fasten the support base 300 to the arm 200.

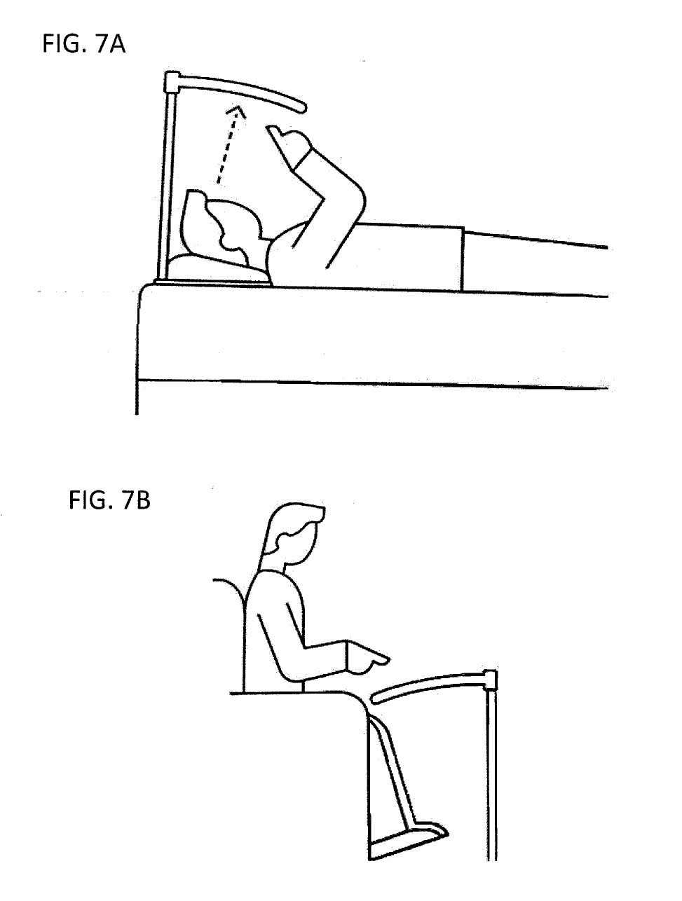

FIGS. 7A and 7B show a user using the present invention. In FIG. 7A, the user is in supine position and sees the screen of the portable electronic device from below. In FIG. 7B, the user sees the screen of the portable electronic device from above.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. An apparatus for supporting a mobile electronic device, comprising:
an arm having a first end and a second end;
a support base connected to the second end of the arm for supporting the apparatus; and
a receiving plate mounted on the arm, wherein the receiving plate comprises a receiving portion adapted to receive the mobile electronic device thereon.

2. The apparatus of claim 1, wherein the receiving portion comprises an annular mounting portion having an inner rim and an outer rim wherein the inner and outer rims are concentric such that the mobile electronic device can mount on the annular mounting portion.

3. The apparatus of claim 2, wherein the receiving portion further comprises an outer rim wall extending upwardly from the outer rim.

4. The apparatus of claim 2, wherein the annular mounting portion is sloped upward towards the arm.

5. The apparatus of claim 2, wherein a diameter of the outer rim is substantially the same or slightly greater than a diagonal of the mobile electronic device.

6. The apparatus of claim 5, wherein a diameter of the inner rim is about a diagonal of a screen of the mobile electronic device so that the mobile electronic device mounts on the annular mounting portion, facing downward, in order for a user to see the screen of the mobile electronic device from below the receiving portion.

7. The apparatus of claim 1, further comprising a circular complementary plate having a sighting aperture wherein the circular complementary plate is adapted to mount on the receiving portion.

8. The apparatus of claim 7, wherein the sighting aperture is constructed in shape and size so that the mobile electronic device can mount on the circular complementary plate facing downward and a user can see a screen of the mobile electronic device from below the circular complementary plate.

9. The apparatus of claim 7, wherein the circular complementary plate is made of paper having a plurality of cutouts for various sizes of sighting apertures to accommodate various sizes of the table computing devices.

10. The apparatus of claim 1, wherein the receiving plate is rotatable with respect to the arm.

11. The apparatus of claim 1, wherein the receiving plate is height, adjustable along the arm.

12. The apparatus of claim 1, wherein the receiving plate further comprises an upper through opening through which the arm passes

13. The apparatus of claim 12, further comprising a sliding stop height adjustably mounted on the arm for preventing the receiving plate from sliding down the arm.

14. The apparatus of claim 13, wherein the receiving plate further comprises a lower through opening formed on a lower end of the upper through opening so that the arm can pass through the upper and lower through openings and the sliding stop is received in the lower through opening.

15. The apparatus of claim 14, wherein the arm is cylindrical and the sliding stop is an annular ring made of rubber or synthetic plastic fastened to the arm by a friction fit.

16. The apparatus of claim 1, wherein the support base is detachably fastened to the second end of the arm by an attachment member.

17. The apparatus of claim 16, wherein the support base comprises a recess formed on a bottom surface of the support base and a through hole formed on the recess.

18. The apparatus of claim 17, wherein, the attachment member is a bolt having a bolt head and an external thread and an internal thread is formed on the second end of the arm, wherein the bolt head is received in the recess of the support base and the external thread mates with the internal thread to fasten the support, base to the arm.

19. The apparatus of claim 1, wherein the support base is made of metal.

20. The apparatus of claim 1, wherein the support base is substantially flat in a ‘c’ shape.
